(19) United States
(12) Patent Application Publication
(10) Pub. No.: US 2011/0116546 A1
(43) Pub. Date: May 19, 2011

(54) SINGLE PASS ADAPTIVE INTERPOLATION FILTER

(76) Inventors: Xun Guo, Beijing City (CN); Kai Zhang, Beijing (CN); Yu-Wen Huang, Taipei City (TW); Chih-Ming Fu, Hsinchu City (TW); Shaw-Min Lei, Taipei County (TW)

(21) Appl. No.: 12/865,125

(22) PCT Filed: Jun. 23, 2010
(86) PCT No.: PCT/CN2010/704327

§ 371 Date: Jul. 28, 2010

Related U.S. Application Data
(60) Provisional application No. 61/223,116, filed on Jul. 6, 2009.

(51) Int. Cl. H04N 7/32

(52) U.S. Cl. 375/240.16; 375/240.12; 375/E07.243; 375/E07.027

(57) ABSTRACT

A method for performing single-pass adaptive interpolation filtering in order to code a bitstream includes: receiving the video frames; selecting an interpolation filter from a competitive filter set; performing motion prediction on a current frame of the video frame utilizing the interpolation filter; encoding the current frame into the bitstream; and updating the competitive filter set.

### BACKGROUND OF THE INVENTION

1. Field of the Invention

This invention relates to Adaptive Interpolation Filters, and more particularly, to an Adaptive Interpolation Filter that only utilizes a single-pass encoding to perform a filtering process.

2. Description of the Related Art

Displacement vectors with fractional pixel resolutions such as ¼ pixel or ⅛ pixel are used in motion compensated prediction process to improve the prediction accuracy. To estimate and compensate for these fractional pixel displacements, interpolation filters are used in video encoding and decoding. An Adaptive Interpolation Filter (AIF) further enhances the coding efficiency compared to a traditional fixed interpolation filter by applying different filters for different inter pictures of a sequence. A Wiener filter based AIF is very popular as it can effectively reduce prediction errors after filtering. This kind of AIF compensates some non-stationary statistical properties of video signals such as motion and aliasing, and also minimizes the prediction errors between the original pixels and the predictive pixels.

Please refer to FIG. 1, which is a diagram of an encoder 100 with an adaptive interpolation filter. As shown in FIG. 1, an encoder 100 comprises both an inter prediction unit 110 and an intra prediction unit 105, and an AIF 115 which generates fractional pixels for motion estimation/compensation and mode decision. Filter information such as filter switch, filter type and filter coefficients are coded in a bitstream by an entropy coding unit 150. A corresponding decoder extracts the filter information from the bitstream and sends it to an AIF in the decoder.

Typically, a two-pass encoding process is required for the adaptive interpolation filter. In a first pass, a predefined interpolation filter is applied to interpolate fractional pixel values for reference pictures and generate a prediction signal. A filter parameter estimator then forms Wiener-Hopf equations by calculating the autocorrelation matrix of the prediction signal and the cross-correlation vector between an original signal and the prediction signal. After that, it solves the Wiener-Hopf equations to generate optimal filter coefficients for each sub-pixel position. In a second pass, these optimal filter coefficients are utilized in the interpolation process of the reference pictures to generate fractional pixels for motion estimation/compensation and mode decision. It should be noted that the second pass can be iteratively performed, but each increase in the number of passes increases the latency and complexity of the system.

There is therefore a trade-off between performance and complexity. More iterations will lead to more accurate motion vectors, but will also increase the encoding latency and computing power. Furthermore, each pass of the AIF must be performed in series. This also requires loading of reference frames from the off-chip memory to the on-chip memory for each iteration. Power consumption and access time are therefore significantly increased.

### BRIEF SUMMARY OF THE INVENTION

It is therefore an objective of the current invention to provide an encoder and decoder with a single-pass Adaptive Interpolation Filter to improve the coding efficiency.

A method for performing single-pass adaptive interpolation filtering in order to code a bitstream according to an exemplary embodiment comprises: receiving the video frames; selecting an interpolation filter from a competitive filter set (CFS) for a particular area of a current frame; performing motion prediction for the particular area of the current frame utilizing the interpolation filter; encoding the current frame into the bitstream; and updating the competitive filter set.

An encoder that performs adaptive interpolation filtering in a single-pass on received video frames comprises: a prediction unit, for performing prediction on a current frame of the received video frames according to original data and reconstructed data to generate prediction samples; a reconstruction unit, coupled to the prediction unit, for reconstructing the prediction samples to form the reconstructed data; a reference frame buffer, for storing the reconstructed data; a coefficient buffer, for storing a competitive filter set; and an adaptive interpolation filter, coupled between the reference frame buffer and the prediction unit, for filtering reconstructed data for the current frame according to an interpolation filter selected from the competitive filter set.

A decoder for decoding a bitstream into video frames comprises: means for parsing the bitstream to generate inter mode information, filter information, and residues; means for generating reconstructed data according to prediction samples and the residues; means for storing the reconstructed data; means for filtering the reconstructed data utilizing an interpolation filter selected from a competitive filter set, wherein the interpolation filter is selected according to the filter information; and means for receiving the inter mode information from the entropy decoding unit and the filtered reconstructed data from the adaptive interpolation filter to generate the prediction samples.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an encoder with AIF.

FIG. 2 is a diagram of an encoder with a single-pass AIF according to an exemplary embodiment of the present invention.

FIG. 3 is a diagram of a decoder utilizing a single-pass AIF according to an exemplary embodiment of the present invention.

FIG. 4 is a diagram illustrating macroblock level filter selection from a competitive filter set.

FIG. 5 is a diagram illustrating sub-pixel interpolation process for a single-pass 2D non-separable AIF according to an exemplary embodiment of the present invention.

FIG. 6 is a diagram illustrating sub-pixel interpolation process for a single-pass 2D separable AIF according to an exemplary embodiment of the present invention.

FIG. 7 is a diagram illustrating sub-pixel interpolation process for a single-pass directional AIF according to an exemplary embodiment of the present invention.

FIG. 8 is a diagram illustrating sub-pixel interpolation process for a single-pass EAIF according to an exemplary embodiment of the present invention.

### DETAILED DESCRIPTION OF THE INVENTION

As detailed in the above, the multi-pass AIF solution costs latency and computational complexity. In the present invention, a number of single-pass AIF designs are proposed for video encoding and decoding. A number of Wiener filter based adaptive interpolation filters are examples of the filter types used for the embodiments of the single-pass AIF.

When an input frame F_{T} is received by an encoder with a single-pass AIF, a competitive filter set (CFS) for a particular area in frame F_{T} is ready for local filter selection. The competitive filter set includes filter coefficients for N different interpolation filters. Note that N may be a fixed number or it can be variable and is adaptively transmitted in the bitstream for each frame. In some embodiments, filter selection is made at block level such as prediction partitions, Macroblock, or super Macroblock level. Each block of the input frame F_{T} may perform calculations to select one best filter from the competitive filter set. For example, the calculation is rate-distortion optimization (RDO), and the best filter is one with the lowest rate-distortion compared to the other filters in the competitive filter set. The competitive filter set may contain optimal filters of nearest preceding frames as well as the H.264 interpolation filter or other fixed interpolation filters. The information of which filter has been selected may be explicitly encoded into the bitstream to inform the decoder.

In some embodiments, a time delayed single-pass AIF generates optimal filter coefficients of a current frame F_{T}, and then includes the generated optimal filter coefficients in the competitive filter set for a next frame F_{T+1}. It is very common that consecutive video frames are very similar with little changes, so the optimal filter coefficients of a current frame F_{T} are often good enough for filtering subsequent frames. In this embodiment, optimal filter coefficients of the current frame F_{T} are solved after the current frame has been encoded completely, and are stored as one of the filters of the competitive filter set used by the subsequent frames. For example, the competitive filter set for the current frame F_{T} includes N filters; if N=2, the filters in the competitive filter set are the standard H.264 filter and the optimal filter for preceding frame F_{T-1}; if N=3, the filters in the competitive filter set are the standard H.264 filter, the optimal filter for frame F_{T-1}, and the optimal filter for frame F_{T-2}. To maintain the bitstream writing order, the optimal coefficients of one frame F_{T} may be transmitted in the slice header of its subsequent frame F_{T+1} in the coding order, and are included in the competitive filter set as a candidate for frame F_{T+1}.

The fact that consecutive frames will not have a huge variation between them leads to the innovative concept of developing an optimal filter for a previous frame that can also be utilized to filter the current frame in the time delayed single-pass AIF design. The example of using rate distortion optimization to locally select an optimal filter minimizes any coding losses which occur by using time delayed adaptive interpolation filters.

Similar to the time delayed single-pass AIF, in another embodiment, a spatial delayed single-pass AIF generates filter coefficients according to previous coded blocks of a current frame F_{T}, and updates the competitive filter set for subsequent blocks of the current frame F_{T}. For example, an optimal filter for an upper half frame can be derived and included in the competitive filter set for an lower half frame. In this case, the optimal filter coefficients of the upper half frame will also be transmitted together with the current frame.

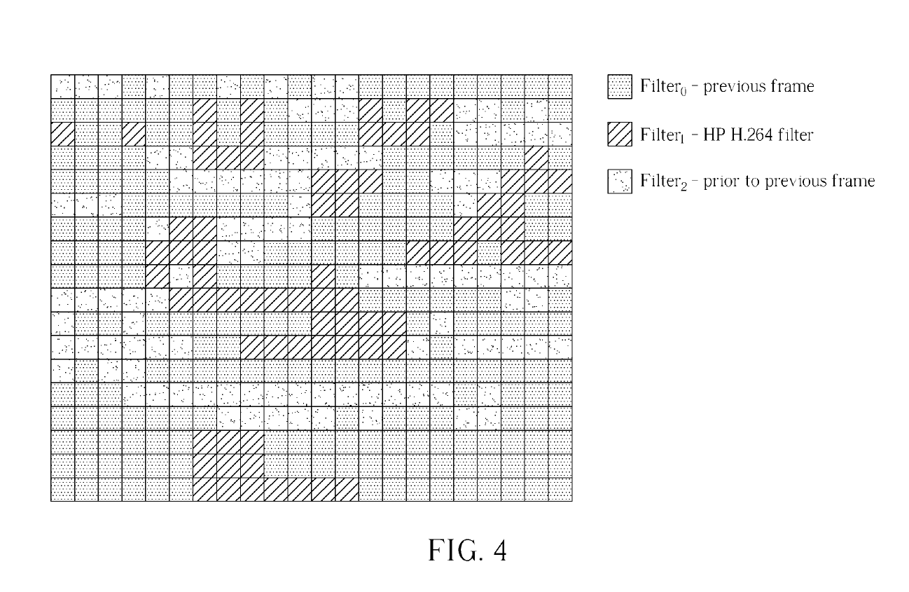

As mentioned above, the competitive filter set selection can be performed at a particular level because not all areas of a frame may yield best results with the same filter. The “optimal filter” for a previous frame may actually be the best filter for most blocks in the current frame. Please refer to FIG. 4, which is a diagram demonstrating macroblock level filter selection for a particular frame. Please note that this is just one example for illustration purposes. As shown in the diagram, each macroblock selects a best filter from the competitive filter set. After encoding this particular frame in FIG. 4, an optimal filter for this frame is calculated. For a frame following the frame shown in the diagram, the calculated optimal filter will be utilized as one candidate filter in the competitive filter set. The block partition for competitive filter set selection can be either the same as or different to the block partition for video encoding. This filter selection information can be encoded in block level (for example, macroblock level) or into the slice header, so that the decoder can utilize this information to correctly decode the received bitstream. Note that the filter selection information and the filter coefficients of the competitive filter set can be encoded in the same or different segments of the bitstream.

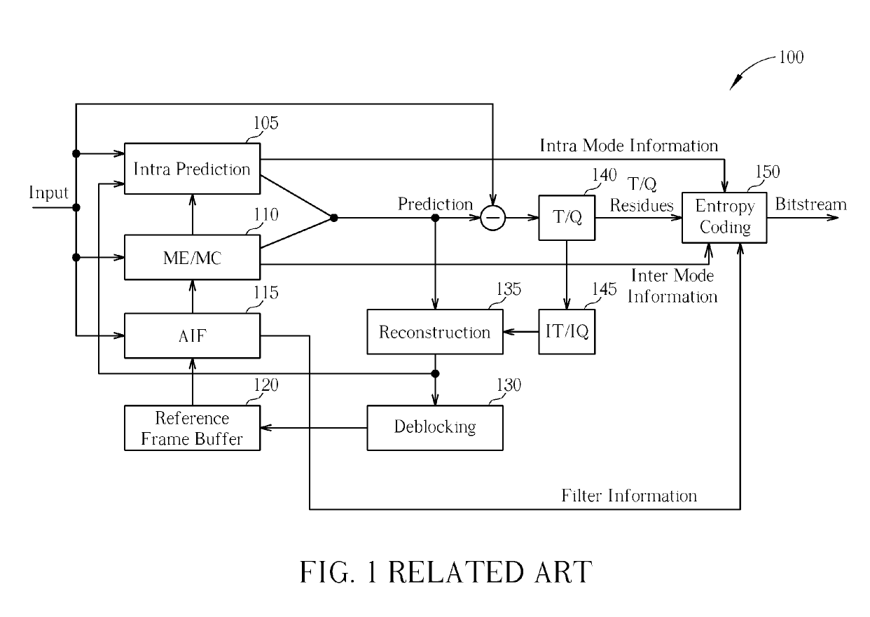

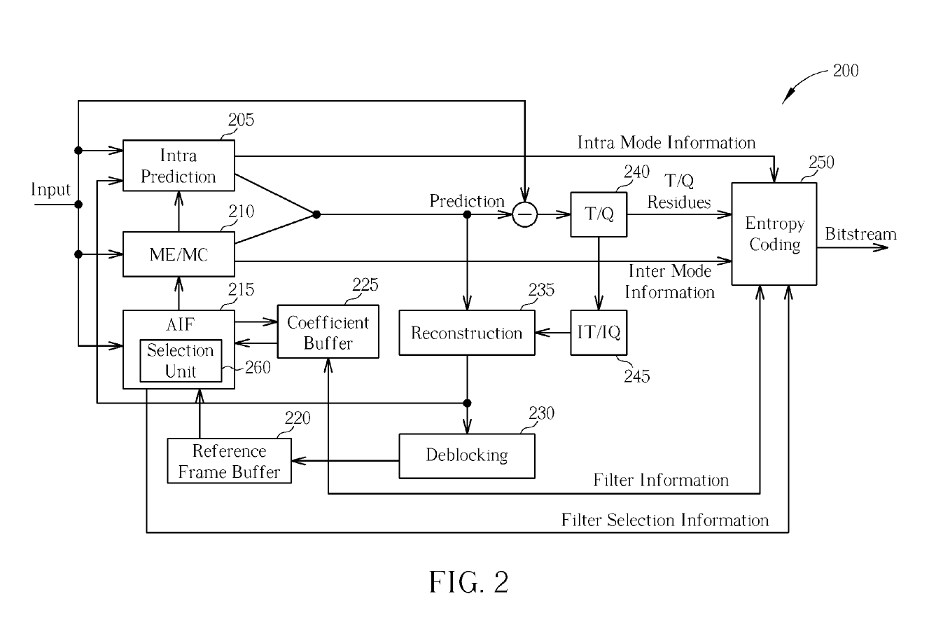

Please refer to FIG. 2 which shows an encoder 200 according to an embodiment of the present invention. The encoder incorporates a coefficient buffer 225, for buffering the competitive filter set. From this competitive filter set, filter information such as filter coefficients for a current frame can be coded into the bitstream by being placed in the slice header. The encoder 200 also includes a selection unit 260 for choosing a filter from the competitive filter set. An example of selecting a filter from the competitive filter set is to compute rate-distortion optimization and select the filter with the lowest rate-distortion measure. The filter selection information is also output to the entropy coding unit 250 for encoding into the bitstream. Other blocks in the diagram are the same as those in FIG. 1, and are therefore not detailed here for brevity.

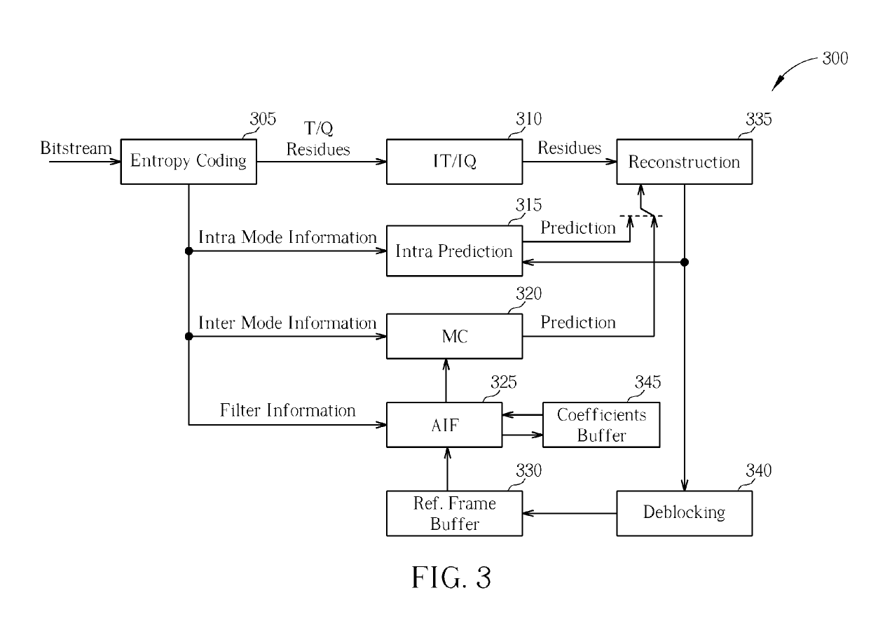

Please refer to FIG. 3, which is a diagram of a decoder 300 according to an exemplary embodiment of the present invention. As shown in the diagram, the decoder 300 comprises an entropy decoding unit 305, intra prediction 315 and inter prediction 320 units, a reconstruction block 335, inverse transform and inverse quantization unit 310, a deblocking unit 340, a reference frame buffer 330, an AIF 325. In some embodiments, the decoder also comprises a coefficient buffer for storing the interpolation filter coefficients of the competitive filter set. In this decoder 300, the entropy decoding unit 305 will parse all information necessary for decoding processes, including the filter information sent directly to the AIF. This filter information may contain the adaptive interpolation filter coefficients transmitted together with each frame and filter selection for each block. As detailed in the above, this filter information may be included in the header of each frame, slice, or macroblock that is encoded in the bitstream. This enables the entropy decoding unit 305 to first decode this information so that the decoder 300 can immediately begin decoding according to the interpolation filter selected by the encoder 200.

It should also be noted that the single-pass adaptive interpolation filtering can be performed for many different kinds of AIF, including (but not limited to) 2D non-separable, 2D separable (SAIF), directional (DAIF), and enhanced (EAIF). For each AIF type listed above, the interpolation method and coefficients calculating method used in their corresponding single-pass AIF may be the same as for their multi-pass AIF. The interpolation methods and coefficient calculating methods differ among different AIF types, however.

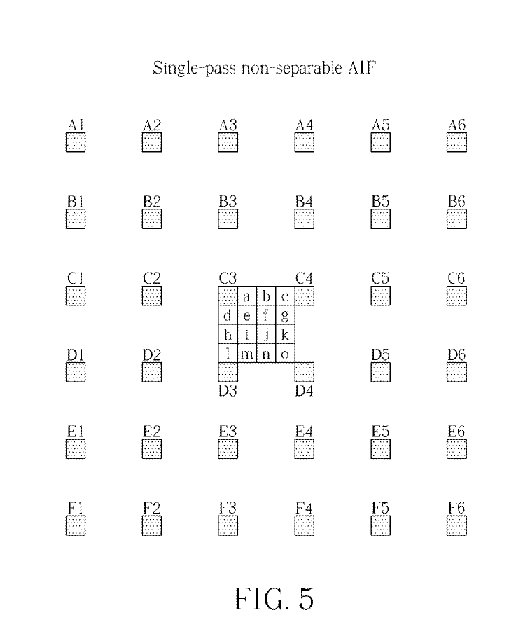

For an example of these different methods, please refer to FIGS. 5˜8. The single-pass AIF can also be applied to an enhanced directional AIF (EDAIF), which is a low complexity version of EAIF. By using a one-dimensional filtering method for the sub-pixel positions in the diagonal lines, EDAIF can be simpler than EAIF while maintaining maximum coding gain. This example is not illustrated.

FIG. 5 is a diagram illustrating sub-pixel interpolation process for a single-pass 2D non-separable AIF. The AIF coefficients may use predictive coding by either pre-defined fixed filter coefficients or AIF filter coefficients from preceding frames. As shown in the diagram, a different number of coefficients are used for each sub-pixel position.

1) For sub-pixel positions a, c, d and l, a 6-tap filter with 6 coefficients is used.

2) For sub-pixel positions b and h, a 6-tap symmetric filter with 3 coefficients is used.

3) For sub-pixel positions e, g, m and o, a 36-tap symmetric filter with 21 coefficients is used.

4) For sub-pixel positions f, i, k and n, a 36-tap symmetric filter with 18 coefficients is used.

5) For sub-pixel position j, a 36-tap symmetric filter with 6 coefficients is used.

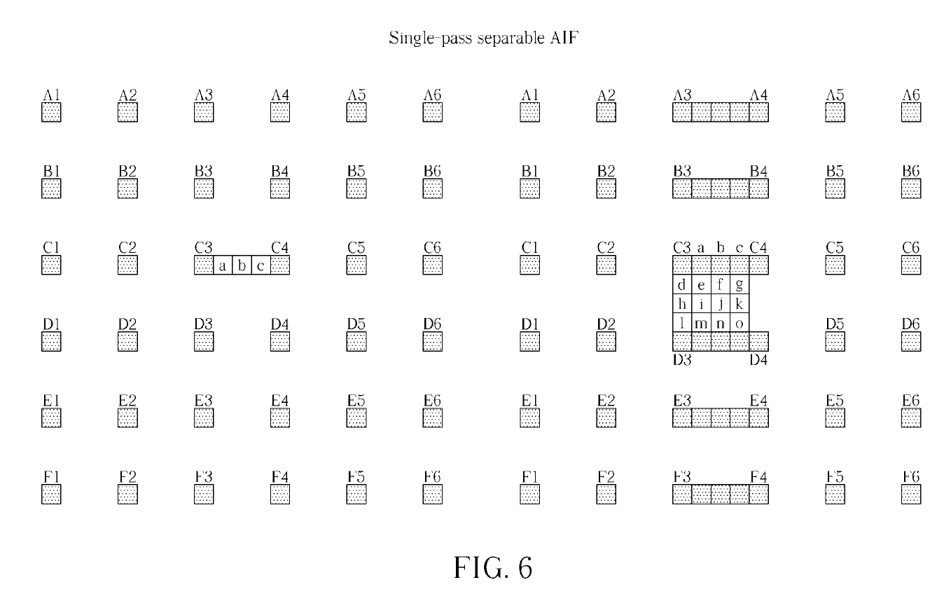

FIG. 6 is a diagram illustrating sub-pixel interpolation process for a single-pass 2D separable AIF. Calculation of the filter coefficients is performed in two steps: first, horizontal filter calculation is performed to calculate the filter coefficients for the fractional pixels in horizontal positions: for example, a, b and c are calculated by 6-tap filters employing pixels C1, C2, C3, C4, C5, and C6 for filter caclulation; and then vertical filtering is performed, using the full-pixels and the calculated sub-pixels a, b and c. For example, d, h and l are calculated by 6-tap filters employing pixels A3, B3, C3, D3, E3, and F3 for filter calculation.

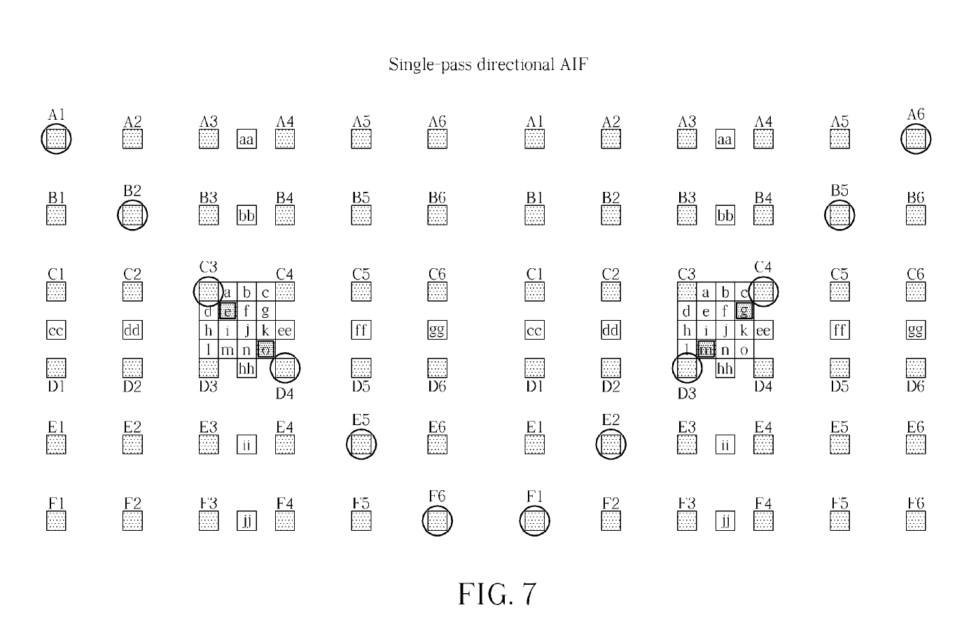

FIG. 7 is a diagram illustrating a sub-pixel interpolation process for a single-pass directional AIF. Compared to 2D non-separable AIF, the integer pixels used in the interpolation process for the middle 9 sub-pixel positions e, f, g, i, j, k, m, n and o are reduced. That is, at most, 12 integer pixels in the two diagonal directions are used (A1˜F6, F1˜A6). For e, o, g and m, only 6 integer pixels are used. For the others, 12 integer pixels are used.

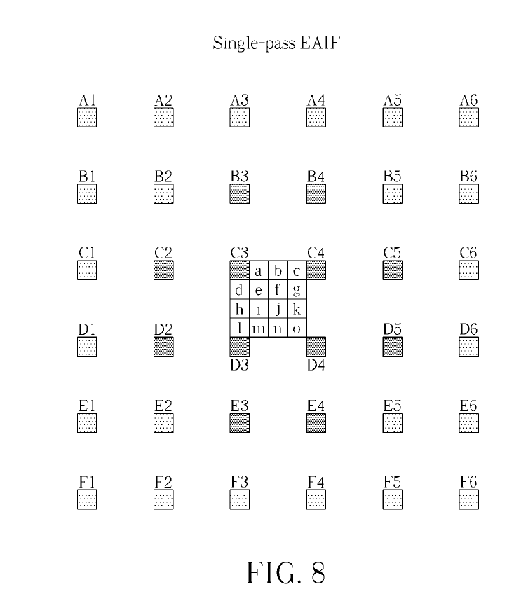

FIG. 8 is a diagram illustrating a sub-pixel interpolation process for a single-pass EAIF. Filter offset is added to the sub-pixel positions, using a summation. An integer-pixel position filter is also added. A modified 12-tap filter is then utilized for the 2D sub-pixel (e˜o) positions, and a 6-tap filter is utilized for the 1D sub-pixel (a, b, c, d, h, l) positions.

In some implementations, the single-pass AIF embodiments described above can operate with two-pass or multi-pass AIFs. In this case, a syntax index needs to be transmitted indicating whether the single-pass AIF is on or off: for example, a two-pass AIF is used instead of a single-pass AIF if the bitstream carries information indicating the single-pass AIF is off. In another example, the AIF can be turned off to skip the filter step according to an index encoded in the bitstream. Single-pass AIFs which choose a filter from a competitive filter set at macroblock, slice or picture level all fall within the scope of the disclosure. In addition, the update of the competitive filter set can also be adaptive, i.e. the update can occur at sub-pixel level, slice level, multi-slice level, or picture level according to filter information encoded in the bitstream. The CFS can consist of a variable number of filters and the number of filters in the CFS may be coded in the bitstream as filter information. It is also possible that more than one set of AIF coefficients can be transmitted for each picture. To inform the decoder of the level and the type of AIF, the corresponding syntax elements are placed in the bitstream. At slice or multi-slice level, syntax elements detailing the AIF coefficients, the CFS information and the number of AIF filter sets can be placed in the slice header, or in the Picture Parameter Set (PPS). At picture level, the AIF coefficients can be transmitted in the slice header or the PPS, while other syntax elements are transmitted in the Sequence Parameter Set (SPS) or PPS. It is also possible that the AIF coefficients and signaling bits (syntax elements which indicate the number of filter sets and the CFS information) are transmitted in an independent package, such as the AIF coefficients parameter set (AIFCPS).

In summary, the present invention proposes a single-pass adaptive interpolation filtering method that allows switching among multiple interpolation filters from a competitive filter set for motion prediction. Filter coefficients and filter selection information may be coded into the bitstream. In some embodiments, the decoder is capable of deriving the filter coefficients, the selected filters, or both, so that this filter information may not need to be coded into the bitstream at the encoder side. The use of an adaptive interpolation filter according to optimal filter coefficients of preceding frames allows interpolation filtering and filter coefficients generation to be performed in a single-pass manner, thereby reducing the encoding latency and memory access overhead of a coding unit.

Those skilled in the art will readily observe that numerous modifications and alterations of the device and method may be made while retaining the teachings of the invention.

1. A method for performing single-pass adaptive interpolation filtering in order to encode video frames into a bitstream, the method comprising:
receiving the video frames;
selecting an interpolation filter from a competitive filter set at a particular level;
performing motion prediction on a current frame of the video frame utilizing the selected interpolation filter at the particular level;
encoding the current frame into the bitstream; and
updating the competitive filter set.

2. The method of claim 1, wherein the particular level comprises one or a combination of block level, slice level, and frame level.

3. The method of claim 1, wherein selecting the interpolation filter further comprises:
computing rate-distortion optimization and selecting the interpolation filter with lowest rate-distortion.

4. The method of claim 1, further comprising:
computing coefficients of an optimal interpolation filter for the current frame and including the optimal interpolation filter for the current frame in the competitive filter set for a subsequent frame.

5. The method of claim 4, further comprising:
encoding filter coefficients of the optimal interpolation filter for the current frame in a slice header of the subsequent frame.

6. The method of claim 1, further comprising:
encoding filter information into the bitstream.

7. The method of claim 6, wherein the filter information comprises filter coefficients of the competitive filter set.

8. The method of claim 7, wherein the filter coefficients of the competitive filter set are encoded in a slice header.

9. The method of claim 6, wherein the filter information comprises filter selection information.

10. The method of claim 1, wherein the competitive filter set is updated for subsequent blocks of the current frame according to filter coefficients derived from previous coded blocks of the current frame.

11. The method of claim 1, wherein the adaptive interpolation filter is a 2D non-separable adaptive interpolation filter, a 2D separable adaptive interpolation filter, a directional adaptive interpolation filter, an enhanced adaptive interpolation filter, or an enhanced directional adaptive interpolation filter.

12. The method of claim 1, wherein the competitive filter set is updated for a subsequent frame according to filter coefficients derived from the current frame.

13. An encoder that performs adaptive interpolation filtering in a single-pass manner on received video frames, comprising:
a prediction unit, for performing prediction on a current frame of the received video frames according to original data and reconstructed data to generate prediction samples;
a reconstruction unit, coupled to the prediction unit, for reconstructing the prediction samples to form the reconstructed data;
a reference frame buffer, for storing the reconstructed data;
a coefficient buffer, for storing a competitive filter set; and
an adaptive interpolation filter, coupled between the reference frame buffer and the prediction unit, for filtering reconstructed data for the current frame according to an interpolation filter selected from the competitive filter set.

14. The encoder of claim 13, further comprising:
an entropy coding unit for encoding the received video frames, wherein filter information is encoded into the bitstream.

15. The encoder of claim 14, wherein the filter information comprises filter coefficients of the competitive filter set.

16. The encoder of claim 15, wherein the filter coefficients of the competitive filter set are encoded in a slice header.

17. The encoder of claim 14, wherein the filter information comprises filter selection information.

18. The encoder of claim 13, further comprising:
a selection unit for determining the interpolation filter from the competitive filter set for the current frame at a particular level.

19. The encoder of claim 18, wherein the selection unit computes rate-distortion optimization and selects the interpolation filter with lowest rate-distortion.

20. The encoder of claim 13, further comprising:
a computing unit for computing coefficients of an optimal interpolation filter for the current frame and sending the coefficients to the coefficient buffer to be included in the competitive filter set for a subsequent frame.

21. The encoder of claim 13, wherein the adaptive interpolation filter is a 2D non-separable adaptive interpolation filter, a 2D separable adaptive interpolation filter, a directional adaptive interpolation filter, an enhanced adaptive interpolation filter, or an enhanced directional adaptive interpolation filter.

22. A decoder for decoding a bitstream into video frames, comprising:
an entropy decoding unit, for parsing the bitstream to generate inter mode information, filter information, and residues;
a reconstruction unit, for generating reconstructed data according to prediction samples and the residues;
a reference frame buffer, for storing the reconstructed data;
an adaptive interpolation filter, for filtering the reconstructed data utilizing an interpolation filter selected from a competitive filter set, wherein the interpolation filter is selected at a particular level according to the filter information; and
a motion compensation unit, for receiving the inter mode information from the entropy decoding unit and the filtered reconstructed data from the adaptive interpolation filter to generate the prediction samples.

23. The decoder of claim 22, wherein the filter information comprises filter coefficients of the competitive filter set.

24. The decoder of claim 23, wherein the entropy decoding unit parses the filter coefficients of the competitive filter set from a slice header.

25. The decoder of claim 22, wherein the filter information comprises filter selection information for a particular area.

26. The decoder of claim 22, wherein the adaptive interpolation filter is turned off to skip the filtering step according to an index in the filter information.

27. The decoder of claim 22, wherein the number of filters in the competitive filter set is determined by the filter information.

28. The decoder of claim 22, wherein the adaptive interpolation filter updates the competitive filter set at picture level, slice level, or multi-slice level according to the filter information.

29. The decoder of claim 22, wherein the entropy decoding unit parses the filter information from one or a combination of a sequence parameter set (SPS), a picture parameter set (PPS), an adaptive interpolation filter coefficient parameter set (AIFCPS), and a slice header.

30. The decoder of claim 22, further comprising a coefficient buffer for storing coefficients of the competitive filter set.
